(19) United States
(12) Patent Application Publication
(10) Pub. No.: US 2008/0235203 A1
(43) Pub. Date: Sep. 25, 2008

(54) Information Retrieval

(76) Inventors: Simon J Case, Redland (GB); Gery M Ducatel, Ipswich (GB); Zhan Cui, Essex (GB)

Correspondence Address: NIXON & VANDERHYE, PC, 901 NORTH GLEBE ROAD, 11TH FLOOR, ARLINGTON, VA, 22203, US

(21) Appl. No.: 10/594,667

(22) PCT Filed: Mar. 10, 2005
(86) PCT No.: PCT/GB05/00937

§ 371 Date: Sep. 28, 2006

(30) Foreign Application Priority Data
Apr. 6, 2004 (GB) 0407816.8

(51) Int. Cl. G06F 7/06; G06F 17/30

(52) U.S. Cl. 707/5; 707/E17.017

(57) ABSTRACT

A method and apparatus are provided for accessing a relevant information resource in response to a user query. An ontology is provided, defining relationships between a plurality of predefined concepts, and between each of the predefined concepts and one or more predefined context phrases. On receipt of a user query, portions of the received query are compared with the context phrases to identify one or more matching phrases and hence, from the predefined relationships with concepts in the ontology, one or more relevant concepts. Concepts identified in respect of the received user query are used to identify a relevant action using predefined relationships between concepts in the ontology and predefined actions, wherein an action comprises providing access to an information resource.

The present invention relates to an information retrieval apparatus and method.

According to a first aspect of the present invention there is provided a method for accessing an information resource, comprising the steps of:

(i) receiving a user query;
(ii) comparing portions of the user query with phrases in a set of predefined phrases to find one or more matching phrases;
(iii) identifying, using predefined relationships between said predefined phrases and predefined concepts in an ontology, one or more concepts relevant to said portions of the received user query; and
(iv) identifying, using predefined relationships between predefined actions and said predefined concepts, one or more actions relevant to the received user query, wherein an action comprises providing access to an information resource.

Preferably, said predefined concepts comprise task concepts and non-task concepts, and the ontology defines, for each task concept, an indication of the number of non-task concepts required to implement a corresponding task.

In a preferred embodiment of the present invention, there is provided a further step:

(vi) in the event that said one or more concepts identified at step (iii) are insufficiently specific to enable a relevant action to be identified at step (iv), identifying from the ontology one or more further concepts related to those identified at step (iii) and requesting input from a user to select one or more of said further concepts for use in step (iv) to identify a relevant action.

Apparatus according to the present invention may be applied as a “just-in-time” information assistant which uses an ontology to improve the management and selection of information to be displayed to a user. In addition to supplying information, preferred embodiments of the present invention enable user queries to be linked to business processes and people. For example, in a contact centre application the apparatus accepts an incoming message, e.g. an operator dialogue with a customer or an email, and matches the message to concepts in the ontology. Combinations of these matched concepts are then used to show information, select a business process or locate a relevant person.

The ontology is a representation of relevant entities along with important properties and their relationships. For example the products supplied by a company are the relevant entities whilst information about which are EEC compliant are important properties. In preferred embodiments of the present invention the ontology is implemented as a hierarchy in which child nodes are instances of a parent node. The ontology enables reuse of defined concepts for different domains of application and enables task-related concepts, e.g. fault, pricing information, to be identified separately from entities such as product types.

It is not just documents which can be attached to entities in the ontology, but also processes and people. A call centre operator for example may therefore be directed more quickly to the correct response in respect of a customer enquiry, i.e. relaying a piece of information, activating the correct business process or contacting the correct person.

Two interactive modes of operation of the apparatus are supported according to preferred embodiments of the present invention: in one mode the apparatus is able to carry on a dialogue with a user in order to resolve a query that is too broad; in another mode the apparatus may monitor telephonic or instant messaging conversations between a customer and a call centre operator, for example, analysing the conversation to continuously identify key concepts in the conversation and to construct relevant queries to automatically supply information, identify processes or people relevant to the subject matter being discussed with the customer.

Preferred embodiments of the present invention use an ontology:

(1) To organise resources such as documents, business processes and domain experts. It effectively provides a concept-based indexing to these resources. As the ontology is formal and highly structured, it allows fast and accurate resource retrieval using structured queries instead of merely generating a list of hits as is often returned by known answer engines.
(2) To help analyse the correct intention of a user query. The invention's dialogue module uses relationships and constraints for each of the defined concepts to ascertain relevant tasks which may apply.

Fuzzy techniques are used to map concepts in the ontology to words and phrases likely to arise in user queries and hence to handle the idiosyncrasies and unstructured nature of user queries.

According to a second aspect of the present invention there is provided an information retrieval apparatus, comprising:

an input for receiving a user query;

an ontological database for storing an ontology defining relationships between a plurality of predefined concepts;

a context phrase database for storing predefined context phrases and, for each context phrase, information defining a fuzzy relationship with an associated concept stored in the ontology;

a concept mapper for comparing portions of a received user query with context phrases stored in the context phrase database to thereby identify and output one or more relevant concepts; and

an action selector operable to identify an action in respect of one or more relevant concepts output by the concept mapper, wherein an action comprises providing access to an information resource in response to the received user query.

Preferred embodiments of the present invention will now be described in more detail, by way of example only, with reference to the accompanying drawings of which:

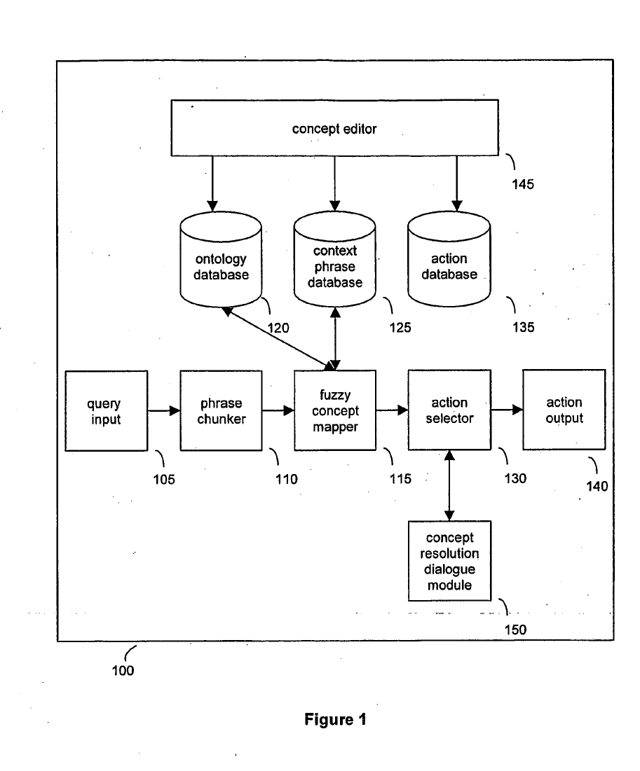

FIG. 1 is a diagram showing features of an apparatus according to preferred embodiments of the present invention; and

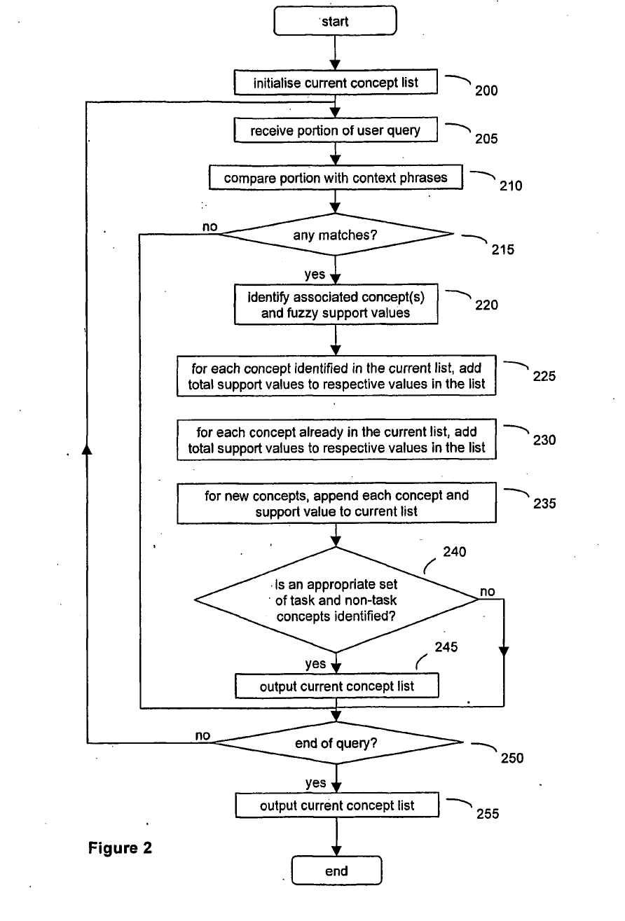

FIG. 2 is a flow diagram showing steps in operation of a fuzzy concept mapper according to a preferred embodiment of the present invention.

A preferred apparatus and its operation according to a preferred embodiment of the present invention will now be described in overview with reference to FIG. 1.

Referring to FIG. 1, the apparatus 100 is provided with a query input 105 arranged to receive a query from a user. Of course, a user query need not be an actual question. In some cases, it may be appropriate simply to ensure that relevant information is always available on-screen to the call centre operator (user of the apparatus 100) while processing a customer enquiry. On receipt of a new query at the query input 105 a new query session is initiated within the apparatus 100. The query input 105 is arranged to receive a user query by a number of different channels. For example, the query may be received in the form of an e-mail message or as a natural language query submitted by means of a web page or an instant messaging interface. Alternatively, speech recognition software may be used to convert a user's spoken dialogue into a text input to the query input 105, in real time, for processing by the apparatus 100 as the dialogue progresses.

Once a query text has been received at the query input 105, or while text is being received, it is passed to a so-called “phrase chunker” 110. The phrase chunker 110 separates input queries into smaller chunks, i.e. phrases which can be matched to concepts. Preferably, the phrase chunker 110 is arranged to divide the received query text into n-grams—sequences of n words or fewer, ideally with n<5—wherein an n-gram does not cross a sentence boundary. Alternatively, the phrase chunker may operate according to a known yet more sophisticated algorithm, designed to identify phrases of up to a predetermined length comprising words more likely to be indicative of the concepts embodied in the user query, eliminating certain “low value” words before constructing those phrases for example.

Output from the phrase chunker 110 is submitted to a fuzzy concept mapper 115 operable to identify one or more predefined concepts stored in an ontology database 120 that appear to have the greatest relevance to terms and phrases output from the phrase chunker 110. The fuzzy concept mapper 115 identifies concepts by firstly looking for context phrases stored in a context phrase database 125 that match terms and phrases contained in the query input. Predefined fuzzy relationships are maintained between concepts stored in the ontology database 120 and context phrases stored in the context phrase database 125. Therefore, having identified one or more matching context phrases (125), the fuzzy concept mapper 115 is able to identify one or more relevant concepts by analysing the respective fuzzy relationships. A more detailed description of the operation of the fuzzy concept mapper 115 will be provided below.

The fuzzy concept mapper 115 is arranged to generate and to update a list of the current concepts identified in a received user query at any one time. For example, if the user query is being captured from dialogue, the fuzzy concept mapper 115 is arranged to continually look for relevant concepts as query text is received (105) and processed by the apparatus 100, to add newly identified concepts to the current concept list and to update fuzzy support values (relevance weightings) associated with those concepts already identified. It is therefore important that when a new user query is received at the query input 105, or when it is otherwise determined that the apparatus 100 should be reset with respect to an ongoing user query, that the list of current concepts is emptied.

The fuzzy concept mapper 115 looks in the ontology (129) for relevant concepts of two types: task and non-task. The ontology (120) defines for each task concept the number and type of non-task concepts that would be required to fully define the task. The fuzzy concept mapper 115 is therefore arranged to recognise an event in which a task concept and a required number of non-task concepts has been identified in respect of a given user query and, at this point, to output the current concept list to the action selector 130. Alternatively, when the user query has been fully analysed, the current concept list is output to the action selector 130 whether or not an appropriate combination of task and non-task concepts has been identified.

The action selector 130 is designed, if necessary, to reformulate the user query in terms of the identified concepts and either to retrieve an appropriate answer to the query or relevant information, or to carry out a relevant action in respect of the user query, for example to place the user in contact with an appropriate person or service to enable an answer/information to be provided, or for the query to be otherwise progressed. The action selector 130 operates with reference to an action database 135 containing information defining a range of predetermined actions and their relationships to appropriate combinations of task and non-task concepts as defined in the ontology database 120. A more detailed description of the operation of the action selector 130 will be provided below.

Having selected an appropriate action in order to provide an appropriate answer/information or access to a relevant service for example, the apparatus 100 outputs the action to the user by means of an action output 140.

The apparatus 100 is also provided with means 150 to implement a concept resolution dialogue with a user, for example to assist the user in finding an appropriate task concept where none has been found by the apparatus 100 for a given user query, or to select a more specific non-task concept where for example the user has employed a particularly broad term in a query and a more specific term is required to fully define the task. Operation of the concept resolution dialogue module 150 will be described in more detail below.

Elements of the apparatus 100 and their operation will now be described in more detail according to a preferred embodiment of the present invention.

Referring to FIG. 1, the ontology database 120 is arranged to store a predefined ontology of concepts relevant to the domain and for each of the domains of application of the apparatus 100. For example, when the apparatus 100 is applied to supporting operators in a call centre, an appropriate ontology (120) would define entities relevant to the products and services handled by the call centre. It is this ontology that enables user queries to be interpreted and reformulated in order for the apparatus 100 to select an appropriate action in response. The ontology database 120 therefore stores an ontology comprising a formal description of the relevant entities and their relationships. Concepts are preferably arranged in a hierarchical fashion so that a given concept typically comprises a parent concept and a set of one or more child concepts. Preferably, the ontology distinguishes task concepts from non-task concepts. Task concepts are abstract tasks, e.g. fault, sales, pricing, overview, etc. Each concept may have associated with it a set of one or more properties. In particular, a non-task concept may have a property that defines, for example, whether specific task concepts can be associated with it.

By way of example, a section of an ontology as may be stored in the ontology database 120 comprises a hierarchy of concepts, as follows:

Tasks
Describe_Benefits
Pricing
Buy
Fault
Reconnect
Information
Alter_details
Compare
   prices
   features

Products
PHYSICAL-PRODUCTS
   CORDLESS-PHONES
   ANSWERING-MACHINES
   FAXES
INTERNET-ACCESS
   DIAL-UP
   MIDBAND
   BROADBAND
PSTN
   Friends&Family

In this example, there are two types of concept in the ontology: “TASKS” and “PRODUCTS.” The ontology is arranged in a hierarchical fashion with TASKS and PRODUCTS being the root nodes of the ontology. Each “child” node under the “parent” PRODUCTS node may have properties to indicate whether particular task concepts may are associated with them. In the above example, all PRODUCTS concepts may have a has_information property set to true. The DIAL_UP concept may have the properties has_pricing_info, can_be_bought and can_have_fault all set to true, implying that it makes sense to apply the corresponding task concepts Pricing, Buy and Fault to the DIAL-UP product, whereas a Friends&Family product may have only the default has_information and alter_details properties set to true because in practice that product cannot be bought and cannot be broken. Default values of certain properties associated with a parent concept may be automatically propagated to corresponding child concepts in the hierarchy if required. For example, INTERNET-ACCESS may have the properties has_pricing_info, can_be_bought and can_have_fault set to true, which also apply to each its child nodes DIAL-UP, MID-BAND and BROADBAND. This propagation can be over-ridden for individual child nodes. Thus, although PSTN may have the property can_have_fault set to true, Friends&Family may have this property set to false.

A further property—“arity”—is defined and stored for each of the task concepts in the ontology. The arity of a task defines how many non-task concepts are involved in the application of the task. In most cases the arity value of a task concept is 1. For example Pricing has an arity of 1 implying that this task is applied to only one concept at a time, e.g. how much is DIAL-UP? Or how much is an XZ70 Answering-machine? Some tasks only make sense when taking into account more than one product; the compare task for example has an arity of 2, corresponding to questions of the type: which is more expensive, DIAL-UP or MID-BAND?

Preferably, all properties of concepts in an ontology are defined and entered into the ontology database 120 by an administrator during a configuration step when setting up the apparatus 100 for use in a particular application domain. The administrator uses a concept editor 145 to enter concepts into a hierarchy of concepts in the ontology database 120 including any task information for the concepts, to enter corresponding context phrases into the context phrase database 125 with appropriate fuzzy support values, and to define and enter actions into the action database 135. The concept editor 145 provides manual data entry facilities, but it may also provide means to derive, semi-automatically, a set of concepts relevant to an intended domain of application on the basis of a set of input documents known to contain relevant information. A known algorithm may be used to extract “key terms” from an input document and/or to suggest where in the hierarchy of the ontology (120) a concept should be placed and which context phrases should be associated with it.

For each concept defined in the ontology database 120 there is provided, in the context, phrase database 125, an associated list of key phrases which are related to the concept. A fuzzy measure of support between 0 and 1 is recorded against each key phrase, indicative of the relevance of the phrase to the associated concept. For example, for the concept task:fault:, the relevant key phrases and measures of support that might be recorded in the context phrase database 125 are:

broken: 0.9

not working: 0.9

loose: 0.3

squeeky: 0.1

The context phrases selected for inclusion in the context phrase database 125 are those phrases most likely to be used in user queries. The context phrase database 125 therefore provides a link between terms that might be expected to occur in a typical user query and concepts defined in the ontology (120). This link is exploited by the fuzzy concept mapper 115 in order to identify, by comparing portions of a received user query that have been output by the phrase chunker 110 with stored context phrases (125), one or more concepts of greatest relevance to the received user query. Preferred steps in operation of the fuzzy concept mapper 115 for identifying one or more concepts of relevance to a new user query will now be described with reference to FIG. 2. The process to be described may operate to analyse a user query that has been received complete, e.g. in the form of an e-mail, or to analyse portions of a user query as it is being received, e.g. during an ongoing conversation between a call centre operator and a customer.

Referring to FIG. 2, the preferred process begins at STEP 200 by initialising the current concept list for the user query so that the process begins with an empty list, or a list comprising one or more default concepts with associated fuzzy support values. A portion of the user query is received at STEP 205 from the phrase chunker 110. At STEP 210 the received portion is compared with context phrases stored in the context phrase database 125. If, at STEP 215, no matching context phrases are found, then processing proceeds to STEP 250 to determined whether the end of the user query has been reached and hence whether or not to move on to the next portion or to terminate.

If, at STEP 215, one or more matching context phrases are found, then at STEP 220 any predefined relationships between those matching context phrases and associated concepts stored in the ontology database 120 are used to select the associated concepts and their respective fuzzy support values. The support values indicate the relevance of each selected concept to the respective matching context phrase and hence to the received portion of the user query. Where a particular concept is selected in respect of more than one matching context phrase then at STEP 225 the respective fuzzy support values are summed to give a total fuzzy support value for the concept in respect of the received portion. Having selected one or more concepts of potential relevance to the user query, each with a fuzzy support value, the next stage in the process is to update the current concept list for the user query. This is achieved in two stages: firstly, at STEP 230, for each selected concept already recorded in the current concept list, by adding the respective fuzzy support value to that recorded in the list to update the list; and secondly, at STEP 235, for each selected concept not already recorded in the list, appending the selected concept and its fuzzy support value to the list.

Having updated the current concept list with the results from analysing that portion of the user query received at STEP 205, then at STEP 240 a test is performed to determine whether an appropriate combination of a task concept and one or more associated non-task concepts, according to the arity value defined for the task concept in the ontology (120), has been identified for the user query. If so, then at STEP 245 the current concept list is output to the action selector 130 and at STEP 250 the test is performed to determine whether any more of the user query remains to be analysed. If, at STEP 240, an appropriate combination of concepts has not yet been identified, then the current concept list is not output at this stage and processing proceeds to STEP 250 to check for the end of the user query.

If, at STEP 250, the end of the user query has been reached, then at STEP 255 the current concept list is output to the action selector 130 whether or not an appropriate combination of task and non-task concepts has been identified. Otherwise, if not the end of the user query, processing returns to STEP 205 to receive a next portion of the user query to analyse.

It is particularly advantageous, where a user query is being processed while it is being received at the query input 105, for example when the output from voice recognition means are being processed in real time, that the current concept list is output to the action selector as soon as an appropriate combination of task and non-task concepts has been identified. In this way the latest current concept list is made available to the action selector 130 with potentially useful task and non-task information, even though the end of the user query has not yet been reached.

According to a preferred embodiment of the present invention, the fuzzy concept mapper 115 may be arranged to operate according to a known fuzzy comparison algorithm to enable a fuzzy comparison to be made between portions of a user query received from the phrase chunker 110 and context phrases stored in the context phrase database 125. In particular, operating a fuzzy comparison algorithm enables the fuzzy concept mapper 115 to identify matching context phrases even though the user query contains typing or spelling errors.

The action selector 130 receives the current concept list from the fuzzy concept mapper 115. The action selector 135 attempts to select and to effect one or more actions specified in the action database 135 of relevance to the concepts in the current concept list. The action database 135 contains information defining predetermined actions that should be performed when a given set of one or more current concepts has been identified (by the fuzzy concept mapper 115) in respect of a received user query. For example, if the current concepts are “freestyle_{—}6010” and “pricing”, then the action database 135 may contain the address for a specific web-page where information on the pricing of products including the freestyle 6010 is available. If the concepts are “PSTN_line” and “fault”, then the action database 135 may specify a link to the user interface of a PSTN fault reporting process.

The action selector 130 looks for concepts of two types: task and non-task. Tasks are general concepts corresponding, for example, to typical call centre activities, e.g. “give_price” and “sell”. If the current concept list includes more than one identified task concept, then the “current task” concept is considered by the action selector 130 to be that task concept with the highest fuzzy support value in the list. Each task concept has an arity value n associated with it in the ontology (120). The arity n of a task specifies how many and what other concepts are needed to complete the task. If an appropriate combination of concepts has been identified by the fuzzy concept mapper 115 then there will be at least n other concepts present in the current concept list for the current task. If there are more than n other concepts in the list, the action selector 130 selects those n other concepts from the list having the greatest fuzzy support values. The action selector 130 takes this combination of the current task and n other tasks and compares it with sets of concepts defined in the action database 135 in order to find a relevant action.

In the case where a task concept could not be identified by the fuzzy concept mapper 115, then a default task of show_general_information of arity 1 is assumed by the action selector 130. In this case, it may be necessary to trigger the concept resolution dialogue module 150 to ask the user to be more specific as to which of the other concepts identified in the current concept list are most appropriate to the user's query or to prompt the user to select a task more appropriate to the user's query than show_general_information. For example, if the user decides in response to a dialogue with the concept resolution dialogue module 150 that they would like to purchase an internet_access product, then whereas it would be appropriate (from the ontology) to apply the show_general_information task to the internet_access product, it would not be appropriate to apply the task sell because the user must first choose between dial_up, mid-band and broadband variations of the internet_access product if the product is to be purchased. In this latter case the concept resolution dialogue module 150 presents the user with a list of possible child nodes to the internet_access concept, read from the ontology (120), from which the user can then select. This dialogue may be repeated until an appropriate node is found—typically this will be a leaf-node of the ontology (120). All leaf nodes are considered appropriate; whereas other nodes of the ontology are considered appropriate only if the task and non-task concepts appear in a set of concepts defined in the action database 135 in respect of a particular action.

As mentioned above, an action may comprise, for example, a link to a web page or to a user interface for a fault reporting system or product ordering/information system, or to a credit card payment system. To effect actions such as these, the action selector 130 may either invoke another software application program referenced in the action database 135 to execute a required interface, or it may generate a standard request message for sending to a network address defined in the action database 135 and to output the response (140). Preferably, the action selector 130 does not necessarily start processes to effect actions; rather it takes users to those parts of a system where they can do this for themselves. Typically, this will involve sending an HTTP request message to the URL of a web-based application program and displaying the resultant web page to the user. An action may be highly structured and represent a semantically correct reformulation of an originally received input query. Hence, high quality results may be achieved in response.

As mentioned above, the apparatus 100 is provided with a concept resolution dialogue module 150 to assist a user in finding an appropriate concept where either no relevant task concept has been found by the apparatus 100 for a given user query or a concept that has been identified is “inappropriate” in that there is no corresponding action defined in the action database 135. This situation may arise for example where a user has employed a particularly broad term in a query and the apparatus 100 requires the user to be more specific in order for an appropriate actionable concept to be identified. For example, if a user entered a query “What is the cost of Broadband?”, then the fuzzy concept mapper 115 may select the concepts “satellite-broadband”, “cable-broadband” and “adsl” from the ontology (120) in respect of the term “broadband” because “broadband” refers to a group of products. However, whereas these concepts each have links to specific actions in the action database 135, the term “broadband” itself does not. Therefore the concept resolution dialogue module 150 may be triggered to prompt the user to select one of the concepts “satellite-broadband”, “cable-broadband” or “adsl” in place of the term “broadband” in order to progress the query.

To give another example, if a user referred in a query to a fault with a “friends_and_family” product, it would be apparent from the ontology (120) that “friends_and_family” is not associated with the task concept “Fault”; the product is not “repairable” as such (it is user-defined). In this case the concept resolution dialogue module 150 would be required to help the user to identify the appropriate task concept to associate with the “friends_and_family” product in order to progress the user query. The user would be prompted to select from one or more alternative task concepts that are relevant to the “friends_and_family” product as defined in the ontology (120). In this respect, through knowing and refining a user query in terms of a concept and corresponding task, preferred embodiments of the present invention are particularly effective in selecting appropriate actions in respect of user queries.

For example, for the user query “my internet is not working”, the fuzzy concept mapper 115 may identify the following list of current concepts: broadband, mid-band and fault (with corresponding fuzzy support values), and outputs this current concept list to the action selector 130. Given the concepts broadband, mid-band and fault, the action selector 130 treats fault as the current task. However, the fault task has an arity value of 1 defined in the ontology so the action selector 130 may determine that a choice must be made between broadband and mid-band in order to define what is meant by “internet” in the user query in the context of the fault task. This choice may be made by triggering the concept resolution dialogue module 150 to query the user

“Select which product you mean:
Broadband
Mid-band”

Once an appropriate selection has been made by the user, a query can be formulated by the action selector 130, based upon the original user query, that is structured and efficient having converted an ambiguous natural language text into precise concepts defined in the ontology (120) and which are also understandable by the user.

The apparatus 100 may be implemented according to an industrial standard J2EE as a server and client model. All the software may be written using Java: Java Beans, Java Servlets and JSPs. The apparatus 100 has been deployed on a J2EE platform from the BEA system. The databases 120, 125 and 135 are implemented as SQL server and Oracle databases. The server side includes the action selector 130, ontology database 120, fuzzy concept mapper 115 and phrase chunker 110. The client side includes JSP web pages and dialogue manager.

1. A method for accessing an information resource, comprising the steps of:
(i) receiving a user query;
(ii) comparing portions of the user query with phrases in a set of predefined phrases to find one or more matching phrases;
(iii) identifying, using predefined relationships between said predefined phrases and predefined concepts in an ontology, one or more concepts relevant to said portions of the received user query; and
(iv) identifying, using predefined relationships between predefined actions and said predefined concepts, one or more actions relevant to the received user query, wherein an action comprises providing access to an information resource.

2. A method according to claim 1, wherein said predefined concepts comprise task concepts and non-task concepts, and wherein the ontology defines, for each task concept, an indication of the number of non-task concepts required to implement a corresponding task.

3. A method according to claim 1 or claim 2, wherein said relationships between said predefined phrases and said predefined concepts in the ontology are fuzzy relationships each represented by a respective fuzzy support value.

4. A method according to any one of claims 1 to 3, further comprising the step:
(v) in the event that a relevant task concept is not identified at step (iii), using a default task concept at step (iv) to identify a relevant action.

5. A method according to any one of the preceding claims, further comprising the step:
(vi) in the event that said one or more concepts identified at step (iii) are insufficiently specific to enable a relevant action to be identified at step (iv), identifying from the ontology one or more further concepts related to those identified at step (iii) and requesting input from the user to select one or more of said further concepts for use in step (iv) to identify a relevant action.

6. An information retrieval apparatus, comprising:
an input for receiving a user query;
an ontological database for storing an ontology defining relationships between a plurality of predefined concepts;
a context phrase database for storing predefined context phrases and, for each context phrase, information defining a fuzzy relationship with an associated concept stored in the ontology;
a concept mapper for comparing portions of a received user query with context phrases stored in the context phrase database to thereby identify and output one or more relevant concepts; and
an action selector operable to identify an action in respect of one or more relevant concepts output by the concept mapper, wherein an action comprises providing access to an information resource in response to the received user query.

7. An apparatus substantially as hereinbefore described with reference to the accompanying drawings.
